(19) United States
(12) Patent Application Publication
(10) Pub. No.: US 2024/0251140 A1
(43) Pub. Date: Jul. 25, 2024

(54) TUNE TIME FOR IP VIDEO STREAMING SERVICES

(71) Applicant: Comcast Cable Communications, LLC, Philadelphia, PA (US)

(72) Inventors: Arthur JOST, Mount Laurel, NJ (US); Philip John STROFFOLINO, Media, PA (US)

(21) Appl. No.: 18/158,655

(22) Filed: Jan. 24, 2023

(51) Int. Cl. H04N 21/643; H04N 21/2662; H04N 21/845

(52) U.S. Cl. CPC H04N 21/64322; H04N 21/2662; H04N 21/8456

(57) ABSTRACT

Delay in initial output of a requested content asset by a computing device may be reduced by sending a first portion of the content asset to the computing device, such as video player, along with a requested information file, such as a manifest file, associated with the content asset. The first portion of the content asset and the manifest file may be processed in parallel by the video player device. The video player device may request a second portion of the content asset according to the manifest file, while the video player device is continuing to process, output and present the first portion of the content asset. The size of the first portion of the content asset may be sized to provide continuous output of the first portion and subsequent portions of the content asset received.

### BACKGROUND

Multiple round-trip (RT) communications and associated delays between a client device and a video content device may contribute to overall delays in tune time. For adaptive bit rate (ABR) streaming formats such as DASH, HLS, MSS, etc., and other formats such as constant bit rate streaming, the client device typically first retrieves a playlist information file, such as a manifest, for a given content item prior to deciding to request an initial and subsequent content fragments. These and other shortcomings are identified and addressed in this disclosure.

### SUMMARY

Systems and methods described herein relate to reducing delays associated with start of presentation of selected content, such as improving tune times for IP streaming services. According to the disclosure, a video content management and delivery system may bundle a descriptive file, such as a manifest file, with a portion of the content asset in response to a client request for the manifest file. Once received, the client device, such as video player, may begin processing and playing the first portion of the content asset at the same time as processing the manifest file. The client may also send a request for additional portions of the content asset to the video content device upon receipt of the manifest. The first portion of the content asset may be sized such that the client experiences uninterrupted playing of any additional content asset portions received from the video content system. Playing the content asset portion received in the response to the manifest request may reduce the RT delays associated with content request methods, which may also reduce tune time for the video content system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following drawings show generally, by way of example, but not by way of limitation, various examples discussed in the present disclosure. In the drawings:

FIG. 1 shows an example system.

FIGS. 2 and 3 show example time graphs.

FIGS. 4A and 4B show communication workflows.

FIGS. 5 and 6 show methods.

FIG. 7 shows a computing device.

### DETAILED DESCRIPTION OF ILLUSTRATIVE EMBODIMENTS

Systems and methods are described herein for improving IP tune time for streaming services. The systems and methods described herein provide an efficient packaging of a content manifest with an initial content asset portion for a client. The client, upon reception, may process the initial content asset portion in preparation for playing the content. The client may also, based on the manifest, request additional content asset portions for processing and playing. The ability of the client to begin processing the initial content asset portion without having to send an additional content asset request may reduce the RTT delays associated with content asset requests. Content may thus be displayed by the client more quickly.

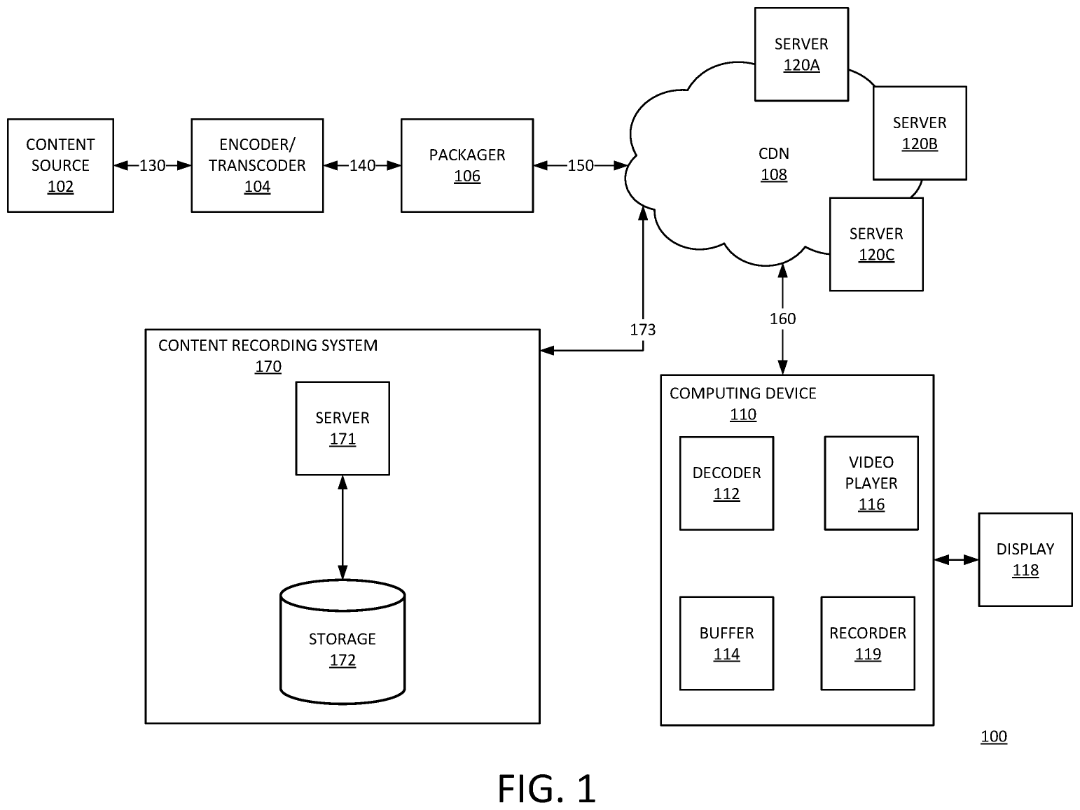

FIG. 1 shows a system 100 for delivering content. The example system 100 may comprise a content source 102, an encoder/transcoder 104, a packager 106, a content delivery network (CDN) 108, and a computing device 110. The techniques for video processing described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, a video player 116, and a digital video recorder (DVR) 119. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, the DVR 119, and the display 118 may be realized in a single device, such as a laptop or mobile device. The decoder 112 may decompress/decode encoded video data. The encoded video data may be received from the encoder/transcoder 104, the packager 106, or the CDN 108.

The content source 102 may comprise a source feed of content from a provider. For example, the content source 102 may comprise a broadcast source, a service provider (e.g., a cable television service provider), a headend, a video on-demand server, a cable modem termination system, the like, and/or any combination of the foregoing. The content source 102 may send content 130 to the encoder/transcoder 104. The content 130 may comprise for example, a program, a television show, a movie, a sports event broadcast, or the like. The content 130 may comprise video frames or other images. For example, the content 130 may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content 130 from the encoder/transcoder 104, the packager 106, the computing device 110, or the CDN 108. The content source 102 may send content 130 to the encoder/transcoder 104 based on a request for video from the encoder/transcoder 104, the packager 106, the computing device 110, or the CDN 108. The content 130 may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein.

The encoder/transcoder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments. For example, content may be segmented into a series of 2-second segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder/transcoder 104 may transcode the content 130 into one or more output streams 140. The one or more output streams 140 may comprise video encoded with different resolutions and/or different bit rates.

The packager 106 may receive the content from the encoder/transcoder 104 or the content recording system 170. For example, the packager 106 may receive the one or more output streams 140 from the encoder/transcoder 104. The packager 106 may determine how the content is to be segmented and put together for delivery to, and eventual playback by, the computing device 110. As part of this process, the packager 106 may segment the content (such as in the event that the content has not yet been segmented) or may re-segment the content (such as in the event that the content had been previously segmented). The packager 106 may additionally insert one or more cues or markers into the content segments at which one or more additional segments, such as segments comprising an advertisement, may be inserted by an upstream client, server, or logical module, such as the server 171.

The packager 106 may create a manifest file associated with the content. For example, the manifest may comprise a DASH manifest. The manifest may comprise information describing various aspects of the associated content that may be useful for the computing device 110 to play back the content and/or for the content recording system 170 to store and retrieve the content. For example, the manifest may indicate the availability of the portions comprising the content, the length of each portion, the number of portions, and/or the proper ordering of the portions necessary to cause playback of the content. The manifest may further include a network location (e.g., a hyper-text transfer protocol (HTTP) uniform resource locater (URL) link or other universal resource identifier (URI)) for each portion from which the content asset may be downloaded, accessed, or retrieved. For example, the network location may indicate a location in storage 172.

The network locations included within the manifest may indicate more than one location or source. For example, the network location for portions corresponding to the content asset may reference a storage location while the network location for portions corresponding to an inserted advertisement may reference a location from outside the system 100 (e.g., at an advertising server). The manifest may include one or more manifest files and may describe multiple versions (e.g., different quality levels) of the content asset, including corresponding information on those portions. For example, the manifest may describe multiple bit rate and/or resolution versions of the content asset. The manifest may be provided, such as by the server 120A-C or 171, to the computing device 110 in response to a request to receive stored content. The computing device 110 may use the manifest files to determine the portions required to play the content asset or a portion of the content asset and download the required portions using the network locations specified in the manifest files.

The packager 106 may generate one or more ABR streams 150 in different ABR streaming formats. The one or more ABR streams 150 may comprise segments or fragments of video, audio, subtitles, etc., and the manifest. The manifest may indicate availability of the ABR stream and segments/fragments/portions and information for requesting the segments/fragments/portions (e.g., via a URL). The packager 106 may send the one or more ABR streams 150 to the CDN 108.

The CDN 108 may comprise one or more computing devices such as servers 120A, 120B, 120C that store content (e.g., the one or more ABR streams 150). The CDN 108 may receive a request for a content asset from the computing device 110. The request may be sent via HTTP. The CDN 108 may authorize/authenticate the request and/or the computing device 110 from which the request originated. The request for a content asset may comprise a request for a channel, a recorded program, a video on-demand asset, a website address, a video asset associated with a streaming service, and the like, and/or any combination of the foregoing. The CDN 108 may send the request to the content source 102, the encoder/transcoder 104, or the packager 106. The CDN 108 may send the requested content 160 to the computing device 110. The one or more servers 120A, 120B, 120C of the CDN 108 may serve the content asset 160 to the computing device 110.

The CDN 108 may group stored content segments based on the anticipated duration of playback of those segments and/or the likelihood of a particular bit rate version of content being requested by the computing device 110. For example, the CDN 108 may store content that is requested more frequently and for a longer duration of play back together in a single storage container as compared with other bit rate versions of the content. The CDN 108 may store content that is more likely to be played for a short time in one or more storage containers.

The system 100 may comprise the content recording system 170 such as a cloud or DVR system, by which the content source 102 may receive a request to record content 173, store the recorded content 173, and potentially fulfill a request to deliver the recorded content 173 for playback. The request to record content may be received from the computing device 110, and the requested content may be delivered to the computing device 110 for playback. The content recording system 170 may include server 171. The server 171 may receive and fulfill a request from the computing device 110 to deliver recorded content to the computing device 110 for playback. The request from the computing device 110 to deliver the recorded content may include identifications of the user (e.g., an account identifier, a username and/or a password), the computing device 110, the requested content, and/or a playback time point or temporal location (e.g., the start of a program or the 12:30 mark in a 30:00 program). The request to deliver the content may indicate a user requesting to skip to a particular section of content of which the initial segments of the content have already been delivered and are being played on the computing device 110. For example, a user may have started viewing the first minute of content and may then decide to skip to a midway point of the content. In this case, the request to deliver the content would indicate that the computing device 110 is requesting the portions of the content from that midway point and after.

Upon receiving a request to deliver stored content to the computing device 110, the server 171 may provide one or more manifest files to the computing device 110 that describe the content and segments thereof, including network locations from which each segment may be downloaded. Using the manifest files, the computing device 110 may download the portions comprising the content. As the computing device 110 downloads sufficient portions of the content, the computing device 132 may begin playback of the content.

The stored content or portions thereof may be stored in the storage 172, which may be accessed by the computing device 110 directly or indirectly via the server 171 to deliver the stored content to the computing device 110. The storage of the content or portions thereof may occur after the packager 106 processes the content. The storage 172 may comprise cloud object storage and/or one or more data storage devices, such as volatile memory (e.g., one or more of random access memory (RAM)), a hard disk drive, a network-attached storage (NAS), a storage area network (SAN), a serial advanced technology attachment (SATA) drive, a solid state drive (SSD), or a non-volatile memory express (NVMe) drive upon which the content or portions thereof may be stored.

As disclosed herein, the computing device 110 may be configured to send a request for a manifest corresponding to a content asset. The request may comprise a request to access (e.g., receive, output, play, decrypt, decode, etc.) the content asset. The request for the content asset may comprise authentication data, such as a token, an address, a username, and/or an account number associated with the computing device 110. Additionally or alternatively, the request may include identification information for the content asset, such as an identification number, a file name associated with the content asset, and the like. In some cases, the request may also include preferred content asset parameters. For example, the request may include a preferred media format, such as an indicated resolution for the content asset, an indicated bit rate for the content asset, an indicated audio language, and the like.

A computing system, such as server 120A-C or 171, may receive the request for the manifest. The computing system may process the request from the computing device 110. Processing the request may include authenticating the computing device 110. Processing the request may include determining the content asset being requested by the computing device 110. Processing the request may include determining the one or more manifest files associated with the requested content asset.

The computing system may be configured to generate a response to the request of the computing device 110. The computing system may select one or more manifest files to include in the response. The one or more manifest files may correspond to the content asset associated with the request of the computing device 110. The one or more manifest files may include reference information for one or more segments of the requested content asset. The reference information may include storage location information for a corresponding one or more portions. The reference information may include a media format for the one or more portions, a resolution of the one or more portions, an audio language for the one or more portions, and the like.

The computing system may also include in the response a first portion of the content asset associated with the request. The first portion of the content asset may include one or more segments of the content asset. The computing system may select a first portion of the content asset, and package the first portion of the content asset with the manifest. The first portion of the content asset may include video data, audio data, subtitle data, and the like.

The computing system may select the first portion of the content asset based on indications contained in the request from the computing device 110. For example, the request may include indicators for preferred content asset formatting, such as bit rate, resolution, audio type, and the like. The computing system may select the first portion of the content asset based on the indicators included in the request. In some cases, the computing system may select the first portion of the content asset based on other information of the system known to the computing system. For example, the computing system may select the first portion of the content asset based on maximum thresholds for the computing device 110, such as maximum resolution output, maximum bit rate, and the like. In some cases, the computing system may select the first portion of the content asset based on current network conditions of the system 100, such as possible bandwidth restrictions, download/upload speed conditions, and the like.

The computing system may select a size of the first portion of the content asset. The first portion of the content asset may, in some cases, be variable, with the computing system capable of selecting larger or smaller sizes for the first portion. The size of the first portion of the content asset may be selected to approximate a round trip time from the computing device 110 to the computing system. Thus, the size of the first portion may be selected based on variables and parameters that determine the round trip time, such as: an estimated processing time for the computing device 110 to process the one or more manifest files of the response: an estimated request time for the computing device 110 to send a second request for additional portions of the content asset: an estimated processing time for the computing system to process the second request for additional portions: an estimated response time for the computing system to send a second response to the request for additional portions: an estimated processing time for the computing device 110 to process the second response, and the like.

In some cases, the computing device 110 may notify the computing system of a preferred size of the first portion. For example, the computing device 110 may send to the computing system a request for the first portion, where the request includes a preferred size of the first portion. In some cases, the request may be included in the request for the manifest. In some cases, the computing device 110 may determine the first portion size based on characteristics of the computing device 110 (e.g., buffer capacity), the associated network, etc.

Additional preferences that may be signaled by the computing device 110 can include content resolution, content bit rate, content audio language, audio and video codecs supported, preferred vs. supported resolutions, buffer capacity, offset from live point, subtitle language, subtitle requirements, audio requirements, network bandwidth, network latency, and the like, may be used to determine the first portion content. In some cases, some of this information can be received from other entities, such as from the computing system (e.g., network bandwidth and latency, etc.) In some cases, this information may be sent to the computing system, which may use the information to determine the first portion content.

The computing system may be configured to determine the time for the computing device 110 to process the one or more manifest files based on current conditions of the network of the system 100. The current conditions may include congestion of the network. The current conditions may include a bandwidth of the network. The computing system may be configured to determine the time to process the one or more manifest files based on current conditions of the computing device 110. The current conditions may include a number of operations being performed by the computing device 110, as an example. The current conditions may include a number of content assets or manifests being processed at a same or overlapping time. The current conditions may include hardware conditions. Examples of hardware conditions include a device not functioning and/or a speed of a CPU of a device. The hardware conditions may affect a time to process the request.

The computing system may be configured to determine the time for the computing device 110 to receive the response based on historical data. The historical data may include previous and/or average times for computing devices to receive manifest files. The historical data may include previous and/or average times to process content asset requests. The historical data may include a previous time and/or an average time for a computing device to receive a response under similar conditions to the current conditions. The historical data may include a previous time and/or an average time to process a content asset request under similar conditions to the current conditions.

The computing system may be configured to determine the time for the computing device 110 to receive the response based on the time for the computing device 110 to process the response request plus an offset time. The offset time may include a predetermined amount of time (e.g., 2 seconds, 3 seconds, etc.). The computing system may be configured to determine the offset time. The offset time may be associated with sending of the response to the computing device 110. The offset time may be determined based on a current condition of the network of the system 100, for example. The current condition of the network may comprise a congestion of the network. The current condition of the network may comprise a bandwidth of the network.

The computing device 110 may receive the response from the computing system and process the response. The computing device 110 may identify the response contains both one or more manifest files associated with the requested content asset, and a first portion of the content asset. In some cases, the computing device 110 may prioritize processing the one or more manifest files prior to the data containing the portion of the first segment. In some cases, the computing device 110 may prioritize processing the first portion of the content asset prior to processing the one or more manifest files. In some cases, the computing device 110 may process the one or more manifest files and the first portion of the content asset in parallel. In some cases, the computing device 110 may process the different data types of the first portion of the content asset in parallel. For example, the computing device 110 may process in parallel video data, audio data, subtitle data, and the like, of the first portion of the content asset.

Once the one or more manifest files are processed, the computing device 110 may retrieve or request additional portions of the content asset. The computing device 110 may identify, from the processed one or more manifest files, storage locations for additional portions of the content asset. The computing device 110 may determine parameters associated with a given content asset, such as bit rate, resolution, and the like. The computing device 110 may select a second portion of the content asset for retrieval based on the one or more manifest files.

The computing device 110 may output the first portion of the content asset for display once the first portion of the content asset is processed. In some cases, the computing device 110 may output the first portion of the content asset for display prior to processing, or finish processing, the one or more manifest files received in the response from the computing system. In some cases, the computing device 110 may initiate outputting the first portion of the content asset prior to the computing device 110 retrieving a second portion of the content asset. In some cases, the computing device 110 may initiate outputting the first portion of the content asset prior to processing, or finish processing, a retrieved second portion of the content asset.

Sending the first portion of the content asset with the one or more manifest files to the computing device 110 has several technical advantages. For example, sending the first portion of the content asset with the one or more manifest files may reduce the number of round trips required for the computing device 110 to begin outputting the content asset for playback. In the scenario where the manifest file is sent prior to any portions of the content asset, the computing device 110 must then process the manifest file and retrieve the first portion of the content asset in a separate communication. This requires at least two round trips of communications between the computing device 110 and other entities within the system 100. By packaging the first portion of the content asset with the one or more manifest files, the computing device 110 may begin processing, and outputting, the content asset more quickly for the user to experience the content asset.

Further, sending the first portion of the content asset with the one or more manifest files may enable the computing device 110 to output the first portion of the content asset followed by the second portion of the content asset without significant delay in between. From the perspective of the user, the transition between play back of the first portion of the content asset and play back of the second portion of the content asset may be seamless or substantially seamless. From the perspective of the user, play back of the continent asset may appear continuous. For example, there may be no buffering or stopping of outputting the content asset caused by transitioning between outputting the first portion of the content asset and the second portion of the content asset.

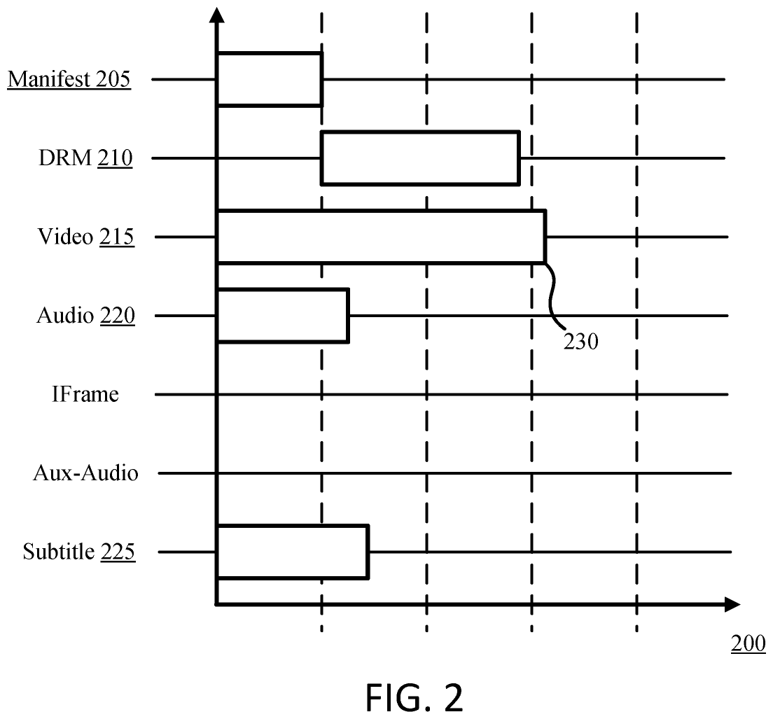

FIG. 2 shows a time graph for a computing device 110. Upon reception of the communication including the manifest files and the first portion of the content asset, the computing device 110 may process the manifest files and the first portion of the content asset in parallel. For example, the computing device 110 may process the manifest data 205, data rights management-type data, such as for example DRM data 210, video data 215, audio data 220, and subtitle data 225, concurrently. Once the DRM data 210, video data 215, audio data 220, and subtitle data 225 are processed, the computing device 110 may output the first portion of the content asset for playback (e.g., at or near point 230). The computing device 110 may output the first portion of the content asset in a reduced number of round trip times for receiving portions of the content asset, as the computing device 110 may output the first portion of the content asset without having to process the manifest files and request the first portion of the content asset based on the manifest files.

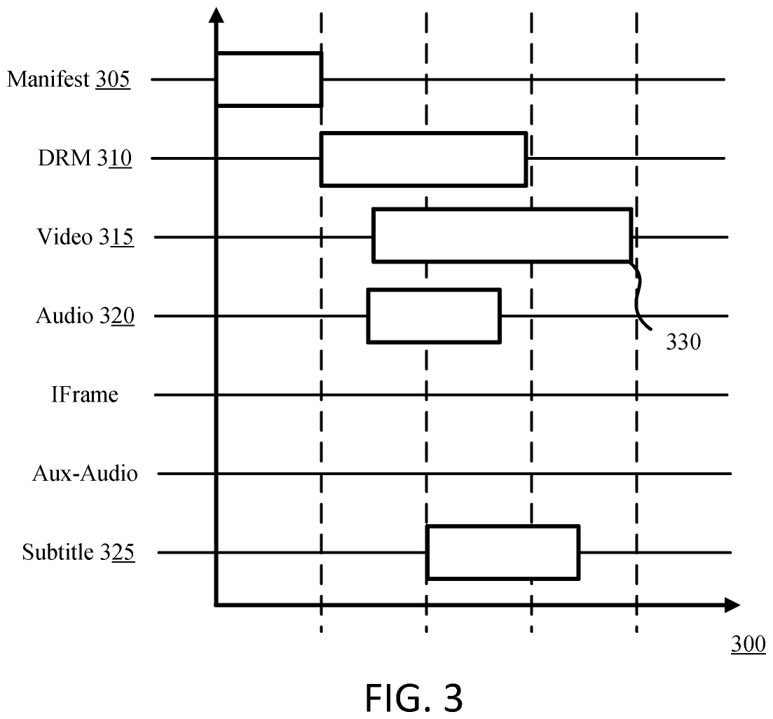

In conventional scenarios where the computing device 110 receives the manifest files without a first portion of the content asset, the computing device 110 first processes the manifest files prior to requesting the first portion. FIG. 3 depicts a time graph 300 for a computing device where the manifest files are sent to the computing deice 110 prior to the first portion of the content asset. As may be seen, the computing device 110 processes the manifest data 305 prior to receiving the first portion. Once the manifest data 305 is processed, the computing device 110 may request, and receive, the first portion of the content data. Even if the computing device 110 were to process the different content asset data types in parallel (e.g., DRM data 310, video data 315, audio data 320, subtitle data 325, and the like), the computing device 110 is still delayed in outputting the first portion of the content asset (e.g., at point 330), particularly with respect to the scenario depicted in FIG. 2 above.

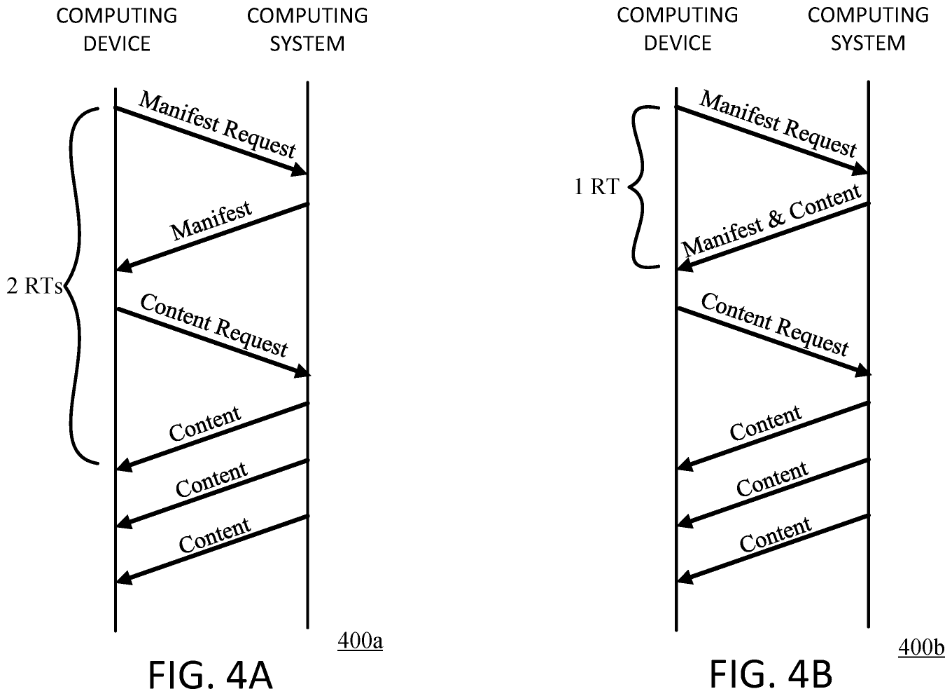

FIGS. 4A and 4B further illustrate the technical advantages provided in the disclosure herein. FIG. 4A illustrates a process flow 400a where a computing device receives a manifest without a first portion of the content asset, which conventional systems utilize. The computing device first processes the manifest files, and sends a content request to the computing system. The computing device receives the portions of the content asset, and ultimately may process and output the content asset, but doing requires at least 2 round trip times to output the content asset. In contrast, FIG. 4B illustrates a process flow: 400b according to the methods described herein. As the computing device receives a first portion of the content asset along with the manifest, the computing device may process and output the first portion of the content asset in as little as one round trip time.

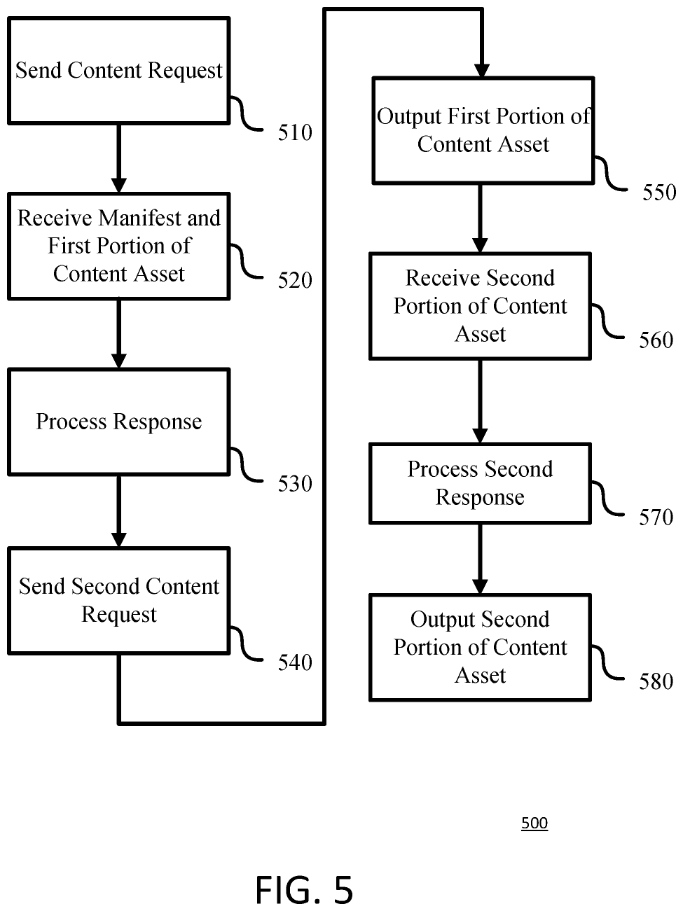

FIG. 5 shows an example method 500. At step 510, a computing device (e.g., computing device 110 in FIG. 1) may send a request for a content asset. The computing device 110 may send the request for the content asset to a computing system (e.g., one or more of servers 120A-C and 171 in FIG. 1). The request may comprise a request to access (e.g., receive, output, play, decrypt, decode, etc.) the content asset. The request for the content asset may comprise authentication data, such as a token, an address, a username, and/or an account number associated with the computing device. Additionally or alternatively, the request may include identification information for the content asset, such as an identification number, a file name associated with the content, and the like. In some cases, the request may also include preferred content asset parameters. For example, the request may include a preferred media format, such as an indicated resolution for the content asset, an indicated bit rate for the content asset, an indicated audio language, and the like. The request may comprise a request to play the content asset from a starting point of the content asset, such as a first frame of the content asset. The request may comprise a request to resume play of a paused and/or stopped content asset.

At Step 520, the computing device may receive a response to the request to access the content asset. The response may include one or more manifest files associated with the content asset, and a first portion of the content asset. The first portion of the content asset may include one or more segments of the content asset. The first portion of the content asset may include video data, audio data, subtitle data, and the like. The one or more manifest files may include reference information for one or more segments of the requested content asset. The reference information may include storage location information for a corresponding one or more segments. The reference information may include media format for the one or more segments, a resolution of the one or more segments, an audio language for the one or more segments, and the like.

The size of the first portion of the content asset may approximate a round trip time from the computing device to the computing system receiving the request. Thus, the size of the first portion may be based on variables and parameters that determine the round trip time, such as: an estimated processing time for the computing device to process the one or more manifest files of the response: an estimated request time for the computing device to send a second request for additional portions of the content asset: an estimated processing time for the computing system to process the second request for additional portions: an estimated response time for the computing system to send a second response to the request for additional portions: an estimated processing time for the computing device to process the second response, and the like.

At Step 530, the computing device may process the response. In some cases, the computing device may process the one or more manifest files prior to the data containing the portion of the first segment. In some cases, the computing device may process the first portion of the content asset prior to processing the one or more manifest files. In some cases, the computing device may process the one or more manifest files and the first portion of the content asset in parallel. In some cases, the computing device may process the different data types of the first portion of the content asset in parallel. For example, the computing device may process in parallel video data, audio data, subtitle data, and the like, of the first portion of the content asset.

At Step 540, the computing device may send a request for a second portion of the content asset. The request for the second portion of the content asset may be based on the processed one or more manifest files. The request for the second portion of the content asset may include an HTTP address for the second portion of the content asset. Further, the second portion of the content asset may be based on a size of the first portion of the content asset. For example, the first portion of the content asset may be two segments of the content asset. Thus, the second portion of the content asset may be the third segment, or a third and fourth segment, and the like, of the content asset.

At Step 550, the computing device may output the first portion of the content asset for playback. In some cases, the computing device may output the first portion of the content asset for display prior to processing, or finish processing, the one or more manifest files received in the response from the computing system. In some cases, the computing device may initiate outputting the first portion of the content asset prior to the computing device retrieving a second portion of the content asset. In some cases, the computing device may initiate outputting the first portion of the content asset prior to processing, or finish processing, a retrieved second portion of the content asset.

At Step 560, the computing device may receive the second portion of the content asset. The second portion of the content asset may be received in response to the request for the second portion of the content asset. The second portion of the content asset may include one or more segments of the content asset. The second portion of the content asset may include video data, audio data, subtitle data, and the like.

At Step 570, the computing device may process the second portion of the content asset. In some cases, the processing may occur serially, such that the various data types of the second portion of the content asset are processed one after the other. In some cases, the processing may occur in parallel, such that the various data types (e.g., video, audio, subtitles, and the like) are processed simultaneously.

At Step 580, the computing device may output the second portion of the content asset. The second portion of the content asset may be outputted to provide a continuous output between the first portion of the content asset and the second portion of the content asset.

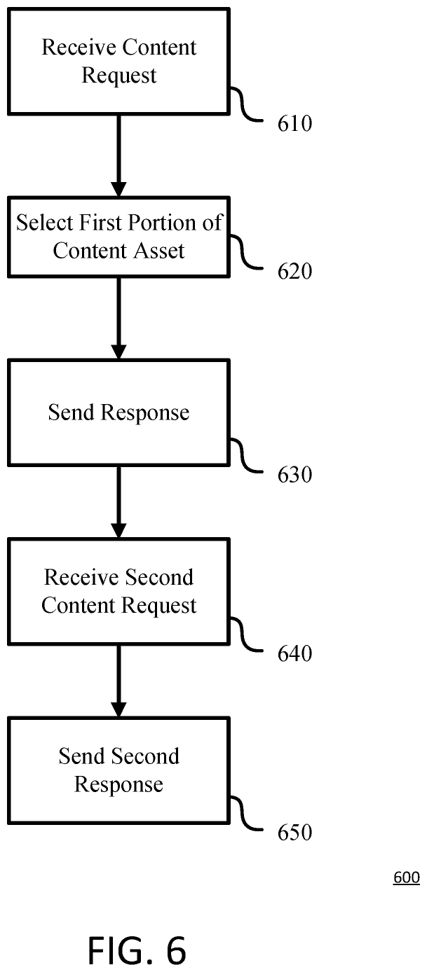

FIG. 6 shows an example method. At Step 610, a computing system (e.g., server 120A-C or 171 of FIG. 1), may receive a request for a content asset. The request may comprise a request to access (e.g., receive, output, play, decrypt, decode, etc.) the content asset. The request for the content asset may comprise authentication data, such as a token, an address, a username, and/or an account number associated with the computing device. Additionally or alternatively, the request may include identification information for the content asset, such as an identification number, a file name associated with the content, and the like. In some cases, the request may also include preferred content asset parameters. For example, the request may include a preferred media format, such as an indicated resolution for the content asset, an indicated bit rate for the content asset, an indicated audio language, and the like. The request may comprise a request to play the content asset from a starting point of the content asset, such as a first frame of the content asset. The request may comprise a request to resume play of a paused and/or stopped content asset.

At Step 620, the computing system may select a first portion of the content asset based on a content resolution, a content bit rate, a content audio language, or a combination thereof. In some cases, request for the manifest may include an indication of a preferred content resolution, a preferred content bit rate, a preferred content audio language, or a combination thereof, and wherein the selecting is further based on the indication. In some cases, the computing system may determine an expected time associated with processing the manifest by the computing device; where a size of the first portion of the content asset is based on the expected time.

At Step 430, the computing system may send a response to the request. The response may include one or more manifest files corresponding to the content asset, as well as the first portion of the content asset. The first portion of the content asset may include one or more segments of the content asset. The first portion of the content asset may include video data, audio data, subtitle data, and the like. The one or more manifest files may include reference information for one or more segments of the requested content asset. The reference information may include storage location information for a corresponding one or more segments. The reference information may include media format for the one or more segments, a resolution of the one or more segments, an audio language for the one or more segments, and the like.

The size of the first portion of the content asset may approximate a round trip time from the computing device to the computing system receiving the request. Thus, the size of the first portion may be based on variables and parameters that determine the round trip time, such as: an estimated processing time for the computing device to process the one or more manifest files of the response: an estimated request time for the computing device to send a second request for additional portions of the content asset: an estimated processing time for the computing system to process the second request for additional portions: an estimated response time for the computing system to send a second response to the request for additional portions: an estimated processing time for the computing device to process the second response, and the like.

At Step 640, the computing system may receive a request for a second portion of the content asset. The request for the second portion of the content asset may be based on the processed one or more manifest files. The request for the second portion of the content asset may include an HTTP address for the second portion of the content asset. Further, the second portion of the content asset may be based on a size of the first portion of the content asset. For example, the first portion of the content asset may be two segments of the content asset. Thus, the second portion of the content asset may be the third segment, or a third and fourth segment, and the like, of the content asset.

At Step 650, the computing system may the second portion of the content asset to the computing device. The second portion of the content asset may be sent in response to the request for the second portion of the content asset. The second portion of the content asset may include one or more segments of the content asset. The second portion of the content asset may include video data, audio data, subtitle data, and the like.

As an example, a subscriber of a content provider's service may select a movie to watch using a remote control in communication with a set-top box. The set-top box may request the selected movie from a video on-demand server via a content distribution network. The request may include a request for one or more manifest files associated with the selected movie. The video on-demand server may determine current conditions of the internal network and/or the content distribution network. The video on-demand server may determine a time based on the observed conditions. The video on-demand server may determine a size (e.g., length, etc.) of a portion of the movie based on the determined time.

The video on-demand server may prepare a first portion of the movie of the determined size. The first portion of the movie may be accessed without the one or more manifest files. The video on-demand server may send the first version of the movie to the set-top box, along with the one or more manifest files associated with the movie. The set-top box may receive the one or more manifest files and the first portion of the movie and begin processing the manifest files and movie. Once the one or more manifest files are processed, the set-top box may identify additional portions of the movie for playback. The set-top box may determine a second portion of the movie out of a plurality of versions of the second portion, for example, by bit rate, resolution, and the like. The set set-top box may send a request for the determined second portion of the movie to the video on-demand server. Once the first portion of the movie is processed, the set-top box may output the first portion of the movie for play back.

As another example, a user may attempt to watch a video on a mobile phone. The video may only be available to users who have an account with a service. The phone may send a request for the video to a server. The video may be available for viewing on a pay-per-view service. The request may include a username and password of an account of the user for the service.

The server may determine a time that it will take for the phone to receive and/or process a first portion of the video. The time may be based on processing capabilities of the mobile phone, current congestion of an internal network (e.g., a network of devices associated with the service), bandwidth of the internal network, and/or historical data.

The server may determine a size for the first portion of the video (e.g., a portion size, a number of frames, a number of packets, etc.) that has a play back time equal to the time to process one or more manifest files associated with the video, in addition to a time for the mobile phone to request, receive, and process a second portion of the video according to the one or more manifest files.

The server may generate the one or more manifest files. The one or more manifest files may include an indication of a storage locations (e.g., a URL, a URI, a URN, etc.) of a second portion of the video and trickplay features associated with play back of the second portion of the video. The server may package the one or more manifest files with the first portion of the video. The server may send the one or more manifest files and the first portion of the video to the phone. The phone may download the first portion of the content from the sent response from the server. The phone may output the first portion of the content, such as without necessarily having to process the one or more manifest files associated with the video.

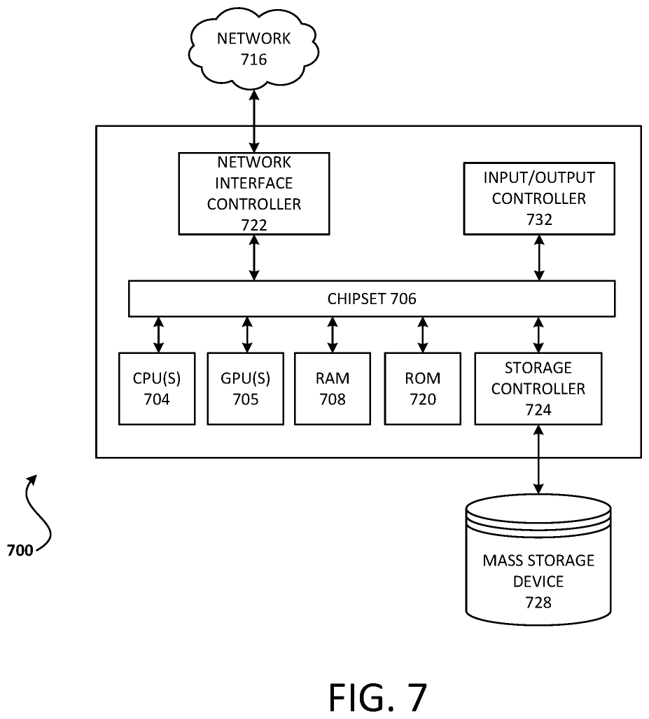

FIG. 7 depicts a computing device 700 that may be used in various aspects, such as the servers, encoders, computing device, and other devices depicted in FIG. 1. With regard to the example architectures of FIG. 1, the devices may each be implemented in an instance of a computing device 700 of FIG. 7. The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 5 and 6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a SATA interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 4-6.

A computing device, such as the computing device 700 depicted in FIG. 7, may also include an input/output controller 732 for receiving and processing input from a number of input devices, such as a key board, a mouse, a touchpad, a touch screen, an electronic stylus, or other type of input device (e.g., a remote control via infrared, Bluetooth, and the like). Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving, by a video content management system and from a video player device, a request for a manifest file associated with a content asset; and
sending, by the computing system and to the computing device, a response to the request, wherein the response comprises the manifest file associated with the content asset and a first portion of the content asset.

2. The method of claim 1, further comprising:
selecting, by the computing system, the first portion of the content asset based on a content resolution, a content bit rate, a content audio language, a buffer capacity of the computing device, or a combination thereof.

3. The method of claim 2, wherein the request for the manifest comprises an indication of a preferred content resolution, a preferred content bit rate, a preferred content audio language, or a combination thereof, and wherein the selecting is further based on the indication.

4. The method of claim 1, further comprising:
determining, by the computing system, an expected time associated with processing the manifest by the computing device: wherein a size of the first portion of the content asset is based on the expected time.

5. The method of claim 1, further comprising:
receiving, by the computing system and from the computing device, a request for a second portion of the content asset according to the sent manifest; and
sending, by the computing system and to the computing device, and in response to the request for the second portion of the content asset, the second portion of the content asset.

6. The method of claim 1, wherein a size of the first portion of the content asset comprises a size configured to have a playing time corresponding to an expected round trip time for the computing device to receive a second portion of the content asset.

7. The method of claim 1, wherein the first portion of the content asset comprises a video segment, an audio segment, a subtitle segment, a set of initialization headers corresponding to the content asset, or a combination thereof.

8. A method comprising:
sending, by a video player device and to a video content management system, a request for a manifest file associated with a content asset; and
receiving, by the video player device and from the video content management system, a response to the request comprising the manifest file associated with the content asset, and a first portion of the content asset.

9. The method of claim 8, further comprising:
processing, by the computing device, the first portion of the content asset in parallel with the manifest.

10. The method of claim 8, wherein the request for the manifest comprises an indication of a preferred content resolution, a preferred content bit rate, a preferred content audio language, or a combination thereof.

11. The method of claim 8, wherein a size of the first portion of the content asset is based on an expected time associated with processing the manifest by the computing device.

12. The method of claim 8 wherein a size of the first portion of the content asset comprises a size configured to have a playing time corresponding to an expected round trip time for the computing device to receive a second portion of the content asset.

13. The method of claim 8, wherein the first portion of the content asset comprises a video segment, an audio segment, a subtitle segment, a set of initialization headers corresponding to the content asset, or a combination thereof.

14. The method of claim 8, further comprising:
processing, by computing device, the manifest and the first portion of the content asset; and
sending, by the computing device and to the computing system, a request for a second portion of the content asset according to the processed manifest, wherein the sending the request for the second portion of the content asset occurs during the processing of the first portion of the content asset.

15. A computing device comprising:
one or more processors; and
memory storing instructions that, when executed by the one or more processors, cause the computing device to:
send, to a computing system, a request for a manifest associated with a content asset; and
receive, from the computing system, a response to the request comprising the manifest associated with the content asset, and a first portion of the content asset.

16. The computing device of claim 15, wherein the instructions, when executed, further cause the computing device to process the first portion of the content asset in parallel with the manifest.

17. The computing device of claim 15, wherein the request for the manifest comprises an indication of a preferred content resolution, a preferred content bit rate, a preferred content audio language, or a combination thereof.

18. The computing device of claim 15, wherein a size of the first portion of the content asset is based on an expected time associated with processing the manifest by the computing device.

19. The computing device of claim 15, wherein a size of the first portion of the content asset comprises a size configured to have a playing time corresponding to an expected round trip time for the computing device to receive a second portion of the content asset.

20. The computing device of claim 15, wherein the first portion of the content asset comprises a video segment, an audio segment, a subtitle segment, a set of initialization headers corresponding to the content asset, or a combination thereof.
